(19) United States
(12) Patent Application Publication
(10) Pub. No.: US 2023/0130054 A1
(43) Pub. Date: Apr. 27, 2023

(54) METHOD FOR COATING A COMPACTED POWDER CAKE, IN PARTICULAR FOR PRODUCING A CAPSULE CONTAINING BEVERAGE POWER

(71) Applicant: Swiss Coffee Innovation AG, Olten (CH)

(72) Inventor: Axel NICKEL, Hemmingen (DE)

(21) Appl. No.: 17/919,817

(22) PCT Filed: Apr. 20, 2021
(86) PCT No.: PCT/EP2021/060223

§ 371 Date: Oct. 19, 2022

(30) Foreign Application Priority Data
Apr. 20, 2020 (EP) 20170381.6

(51) Int. Cl. A23P 20/10; B65B 29/02; A23L 2/395; A23P 10/25; A23P 10/30; A23F 3/32; A23F 5/38; A23G 1/54

(52) U.S. Cl. CPC A23P 20/105; B65B 29/02; A23L 2/395; A23P 10/25; A23P 10/30; A23F 3/32; A23F 5/385; A23G 1/54; B65D 85/8043

(57) ABSTRACT

A method for coating a powder compact, in particular for producing a capsule containing powdered beverages, comprises the following steps:
i) Providing a powder compact of a powder containing at least one polysaccharide,
ii) Providing a container having a container wall of a perforated material enclosing a cavity, the container having an inlet opening for introducing coating liquid into the cavity,
iii) placing the powder compact in the cavity of the container, the powder compact being smaller than the volume of the cavity,
(iv) introducing a coating liquid containing a coating material into the cavity via the inlet port,
v) immersing the container filled with the powder compact and the coating material in a hardener liquid containing a hardener compound, the viscosity of the hardener liquid being lower than the viscosity of the coating liquid, and
vi) Removal of the container from the hardener liquid and removal of the coated powder compact from the container.

The present invention relates to a method for coating a powder compact, in particular for producing a capsule containing beverage powder, which is suitable for preparing a beverage, such as cocoa, tea or coffee.

In recent years, coffee capsules, whose capsule walls are usually made of stainless steel, aluminum or plastic, have been increasingly used in addition to coffee pods for the portion-wise preparation of beverages, especially brewed coffee. Such capsules allow coffee powder to be stored for a longer period of time without loss of aroma. In addition, such capsules allow a quick and user-friendly production of a coffee portion with the desired flavor by inserting a capsule with the desired coffee type into an adapted coffee machine, in which hot water is then pressed through the capsule and brewed coffee is produced from it. However, such capsules are comparatively expensive, partly because of the capsule material used and the production-intensive capsule design. Furthermore, such capsules are environmentally problematic. On the one hand, the capsules are not recyclable and are generally disposed of by consumers as residual waste after use. Recycling of coffee capsules therefore practically does not take place, which is particularly worrying in the case of aluminum-based coffee capsules, since aluminum production is very energy-intensive, resulting in a particularly poor CO₂ balance for such capsules. Another major disadvantage is that such capsules are not biodegradable and therefore cannot be disposed of biologically. Considering that well over 2 billion coffee capsules are consumed each year in Germany alone, this is a serious problem.

Capsules made of alternative materials have already been proposed to at least partially circumvent the above problems.

From WO 2010/006979 A1, for example, capsules are known which are filled with coffee or tea in their interior and comprise a capsule wall which, in addition to the capsule contents, also contains water as a structuring component. However, to form a stable capsule wall, it is necessary for the capsule to be cooled below the freezing point of the structuring component, because the structuring component melts when its freezing point is exceeded and moistens the capsule contents. This naturally limits the use of such capsules considerably.

WO 2009/053811 A2 describes a capsule that can contain ground coffee, cappuccino powder, chocolate powder, milk powder or tea powder. The capsule comprises two half-shells which form the capsule walls. Here, the capsule walls are made of a material that is soluble in water and dissolves during the brewing process. In this concept, the capsule wall material is dissolved during the brewing process and thus becomes part of the prepared beverage, which can have an undesirable effect on the taste. Apart from this, the production of such capsules is complex and expensive.

In order to overcome the aforementioned disadvantages, it has also already been proposed in EP 3 115 316 A1 to provide a capsule particularly suitable for the production of coffee, comprising a compact of a powder containing at least one polysaccharide, such as coffee powder, said compact being coated with at least one coating layer, said at least one coating layer comprising a crosslinked polysaccharide. Preferably, the coating layer is composed of an alginate and is obtained by immersing the compact in an alkali metal alginate solution before immersing the thus treated compact in an alkaline earth metal salt solution. In this process, the alkaline earth metal ions act as crosslinkers as they form coordinative or ionic bonds with groups of the alginate. This provides a water-insoluble coating that does not affect the taste of the beverage produced from the capsule and provides sufficient stability of the capsule to ensure transport and touch protection without significant loss of flavor to the capsule contents. Due to the comparatively high viscosity of alkali metal alginate solution, the coating material adheres poorly to the hydrophobic coffee powder compact. This makes it difficult to transfer and immerse the powder compact from the alkali metal alginate solution into the alkaline earth metal salt solution. Even if this is done carefully and with the aid of specially designed holders, obtaining a sufficiently uniform coating thickness on the powder compact is difficult, if possible at all.

Based on this, the present invention is based on the task of providing a method for coating a powder compact, in particular for producing a capsule containing beverage powder for the portion-wise preparation of beverages from beverage powder, such as cocoa, tea and coffee, with which a coated powder compact with a uniform coating thickness is obtained simply and reliably.

According to the invention, this task is solved by a method for coating a powder compact, in particular for producing a capsule containing beverage powder, which, comprises the following steps:
i) Providing a powder compact of a powder containing at least one polysaccharide,
ii) Providing a container having a container wall of a perforated material enclosing a cavity, the container having an inlet opening for introducing coating liquid into the cavity,
iii) Placing the powder compact into the cavity of the container, where the powder compact is smaller than the volume of the cavity,
(iv) introducing a coating liquid containing a coating material into the cavity via the inlet port,
v) immersing the container filled with the powder compact and the coating material into a hardener liquid containing a hardener compound, the viscosity of the hardener liquid being lower than the viscosity of the coating liquid, as well as
vi) Removal of the container from the hardener liquid and removal of the coated powder compact from the container.

This solution is based on the knowledge that by using a container having a container wall made of a perforated material enclosing a cavity, the container having an inlet opening for introducing coating liquid, a powder compact can be easily and reliably coated while obtaining a uniform thickness of the coating of the powder compact. Since the powder compact introduced into the cavity of the container in step iii) has a smaller volume than the cavity, the powder compact fits into the cavity, a space is formed between the powder compact and the inside of the container wall of perforated material bounding the cavity of the container, which space can be filled with the coating liquid in step iv) by introducing the coating liquid. Due to the perforation as well as the inlet opening, the air initially present in the intermediate space is displaced by the coating liquid, so that in step iv) the entire intermediate space can be completely filled with the coating liquid. As the powder compact floats on the coating liquid introduced, the powder compact is surrounded by a uniformly thick layer of coating liquid when the interstitial space is completely filled with the coating liquid. By immersing the container filled with the powder compact and the coating material in the hardener liquid, a uniform coating thickness is thus easily and reliably obtained. Since the hardener liquid has a lower viscosity than the coating liquid, during step v) the hardener liquid can enter the container quickly and uniformly over the surface of the container through the perforated material, i.e., through the small holes thereof, and thus contact the coating liquid, whereas the coating liquid does not exit the container through the perforated material due to its higher viscosity. Thus, a coated powder compact with a uniform coating thickness is easily and reliably obtained by the process.

For the purposes of the present invention, perforated material means a material having a plurality of small holes, the holes being regularly arranged in the material and each having at least substantially the same shape and size.

With respect to the polysaccharide-containing material of which the powder compact provided in step i) is composed, the present invention is not particularly limited. In particular, good results are obtained when the powder compact contains or preferably is composed of a material selected from the group consisting of coffee, tea, drinking chocolate, cocoa and milk powder. Good results are obtained in particular when the powder compact consists of ground coffee powder.

For the purposes of the present invention, a powder compact is understood to be compressed powder. Good results are obtained in particular if the powder compact prepared in step i) has been produced by pressing powder, in particular coffee powder, at a pressure of 1 to 100 MPa, particularly preferably at a pressure of 5 to 50 MPa and very particularly preferably at a pressure of 15 to 30 MPa. This provides sufficient compaction to ensure that the powder compact can be securely coated and a good oxygen barrier is achieved. At lower pressures, there is insufficient cohesion, and at higher pressures, there is excessive compaction, which under certain circumstances relaxes again after removal from the press, which can lead to destruction of the capsules.

In principle, the powder compact can have any shape. Preferably, the powder compact is spherical. Good results are obtained in particular when the diameter of the spherical powder compact is 1 to 10 cm, preferably 1 to 5 cm, particularly preferably 2 to 4 cm and most preferably 2.7 to 3.7 cm.

In line with this, it is preferred that (also) the cavity of the container is spherical in shape, i.e. the inner surface of the container is spherical.

In further development of the invention, it is proposed that the diameter of the cavity in the container is 0.5 to 10.0 mm, preferably 1.0 to 8.0 mm and particularly preferably 3.0 to 6.0 mm larger than the diameter of the spherical powder compact used.

According to a particularly preferred embodiment of the present invention, the perforated material of which the container wall of the container is composed is a wire mesh. For the purposes of the present invention, a wire mesh is understood to be a flat structure with similar holes in a regular arrangement, which are formed by crossing warp and weft wires at right angles. On the one hand, wo wire meshs are comparatively inexpensive and easy to process or form, and on the other hand, the holes contained therein are arranged in a particularly regular manner and have the same shape and size.

Preferably, the porous material, preferably the wire mesh, has holes of such a size or mesh size that the more viscous coating fluid does not exit the container cavity and thus the container through the perforated material, preferably the wire mesh, but the less viscous hardener fluid enters the container quickly and uniformly over the surface of the container through the perforated material, preferably the wire mesh, when the container is immersed in the hardener fluid.

In particular, good results are obtained when the holes of the porous material of the container wall have a diameter or the wire mesh has a mesh size of 0.01 to 0.30 mm, preferably 0.02 to 0.21 mm, more preferably 0.04 to 0.08 mm, even more preferably 0.05 to 0.075 mm, and most preferably 0.058 to 0.068 mm, such as about 0.063 mm.

As described, a wire mesh is preferably used as the porous material for the container wall. Preferably, the wire mesh is made of steel or stainless steel. In further development of the idea of the invention, it is proposed that the wire mesh has a wire thickness of 0.01 to 0.30 mm, preferably of 0.02 to 0.20 mm, particularly preferably of 0.03 to 0.10 mm, most preferably of 0.04 to 0.06 mm and most preferably of 0.045 to 0.055 mm.

According to the invention, the container provided in step ii) comprises an inlet opening for introducing coating liquid into the cavity. In order to be able to introduce the coating liquid well through the inlet opening into the cavity of the container, it is proposed according to a further preferred embodiment that above the inlet opening of the container a tube is arranged which is fixedly connected to the container and which is preferably arranged with its longitudinal axis radially on the container wall.

In principle, the tube can be made of any material, such as the same material as the container, i.e. preferably steel or stainless steel. However, the tube is preferably unperforated.

In principle, the present invention is not limited with respect to the shape of the tube. For example, the tube may have a rectangular, square, round, elliptical, oval or polygonal cross-section. Preferably, the tube is a rectangular tube or a round tube having a length of from 1.0 to 5.0 cm and preferably from 2.0 to 4.0 cm. In particular, good results are obtained with a round tube having an inside diameter of 0.1 to 5.0 mm, preferably of 0.5 to 2.5 mm, more preferably of 0.75 to 1.25 mm, most preferably of 0.9 to 1.1 mm and most preferably of 0.95 to 1.05 mm.

In order to be able to easily introduce the powder compact into the cavity of the container and to be able to easily remove the coated powder compact from the cavity of the container, it is proposed in further development of the idea of the invention that the container is constructed from two halves, which are connected to each other by a connecting element, such as a hinge, and can thus be easily brought together to form the closed container. In the case of the preferred spherical configuration of the container, the container preferably has two half-calottes connected to each other via a hinge. Both half-calottes preferably each have the same dimensions and are each formed from the same perforated material. If the two half-calottes are each placed on top of each other with their equator in an exact fit, they delimit a spherical cavity except for the inlet opening, which is preferably formed in only one of the two half-calottes. Good results are obtained in particular if the inlet opening is provided at the pole of one of the two half-calottes.

The lower, near-equatorial region of the two half-calottes may also have a slightly different radius of curvature, as seen in cross-section, than the upper region.

To make it easier to place the two half-calottes exactly and completely on top of each other, both half-calottes can have an outward collar at the equator, which surrounds each half-calotte in a circular ring.

In principle, the present invention is not limited with respect to the shape of the inlet opening. For example, the inlet opening may have a rectangular, square, circular, elliptical, oval or polygonal cross-section. Preferably, the inlet opening has a circular cross-section, wherein the diameter of the inlet opening is preferably 0.1 to 5.0 mm, further preferably 0.5 to 2.5 mm, more preferably 0.75 to 1.25 mm, even more preferably 0.9 to 1.1 mm, and most preferably 0.95 to 1.05 mm.

In order to be able to carry out the simultaneous or parallel coating of several powder compacts easily and quickly, the process can also be carried out with a plurality of containers, whereby a container designed as described above is connected in a rack with one or more other containers of the same dimensions. In this way, the plurality of containers can be immersed simultaneously in a bath of hardener liquid in a single step. In this embodiment, the rack preferably comprises 2 to 100 and in particular 5 to 50 containers.

In principle, the process is not particularly limited with respect to the chemical nature of the coating material contained in the coating liquid and the hardener compound contained in the hardener liquid, as long as the hardener liquid has a lower viscosity than the coating liquid. Examples of suitable coating materials include those selected from the group consisting of starch, cellulose, chitin, carrageenan, agar and alginates.

Preferably, the viscosity of the hardener liquid is 0.01 to 100 mPa·s, more preferably 0.1 to 20 mPa·s and most preferably 0.5 to 10.0 mPa·s, such as 1 mPa·s, whereas the viscosity of the coating liquid is preferably more than 100 to 10.000 mPa·s, particularly preferably 200 to 5,000 mPa·s and most preferably 300 to 1,000 mPa·s, such as 500 mPa·s.

The hardening compound is selected to crosslink the coating material, preferably via i) covalent bonds or ii) ionic and/or coordinative bonds.

According to a very particularly preferred embodiment of the present invention, alginate is used as the coating material in the process. This has the advantage that a homogeneous coating is formed simply and quickly by crosslinking with alkaline earth metal ions, namely a water-insoluble coating which does not impair the taste of the beverage produced from the coated powder compact, such as coffee. In addition, this provides sufficient stability of the coated powder compact to ensure transport and touch protection, without its contents suffering any appreciable loss of flavor. In addition, calcium alginate is excellently biodegradable. Another advantage is that calcium alginate is an approved food additive with the E number E405, which means it is harmless to health.

It is therefore particularly preferred that a coating liquid is used which contains an alkali metal alginate (in particular sodium alginate) as the coating material, and a hardener liquid is used which contains an alkaline earth metal salt (in particular a calcium salt, such as calcium chloride) as the hardening compound.

Good results are obtained, for example, if an alkali metal alginate solution is used as the coating liquid, preferably an aqueous 0.5 to 5 wt. % alkali metal alginate solution and, particularly preferably, an aqueous 0.5 to 5% by weight-sodium alginate solution is used as coating liquid, and an alkaline earth metal salt solution, preferably an aqueous 1 to 7% by weight alkaline earth metal salt solution and, particularly preferably, an aqueous 1 to 7% by weight calcium chloride solution is used as hardener liquid.

According to another very particularly preferred embodiment of the present invention, the method comprises the following steps:
i) Providing a powder compact of a powder containing at least one polysaccharide,
ii) providing a container having a container wall of wire mesh enclosing a cavity, the container having an inlet opening for introducing coating liquid into the cavity, and, the wire mesh having a mesh size of from 0.01 to 0.30 mm, preferably from 0.02 to 0.21 mm, more preferably from 0.04 to 0.08 mm, even more preferably from 0.05 to 0.075 mm, and most preferably from 0.058 to 0.068 mm,
iii) Placing the powder compact into the cavity of the container, where the powder compact is smaller than the volume of the cavity,
(iv) introducing a coating liquid containing an alkali metal alginate into the cavity via the inlet port,
v) immersing the container filled with the powder compact and the coating material in a hardener liquid containing an alkaline earth metal salt, the viscosity of the hardener liquid being lower than the viscosity of the coating liquid, and
vi) Removal of the container from the hardener liquid and removal of the coated powder compact from the container.

In any of the above embodiments, steps i) to vi) may be performed in the order mentioned. It is equally well possible to perform step ii) before step i) or sim ultaneously therewith.

In addition to the above steps, the process may further comprise, as step vii), drying the coated powder compact obtained in step vi).

According to a further preferred embodiment, it is provided that the thickness of the coating of the dried coated powder compact is between 10 and 600 μm, and particularly preferably between 20 and 40 μm.

The present invention is explained below with reference to figures illustrating, but not limiting, the invention.

It shows:

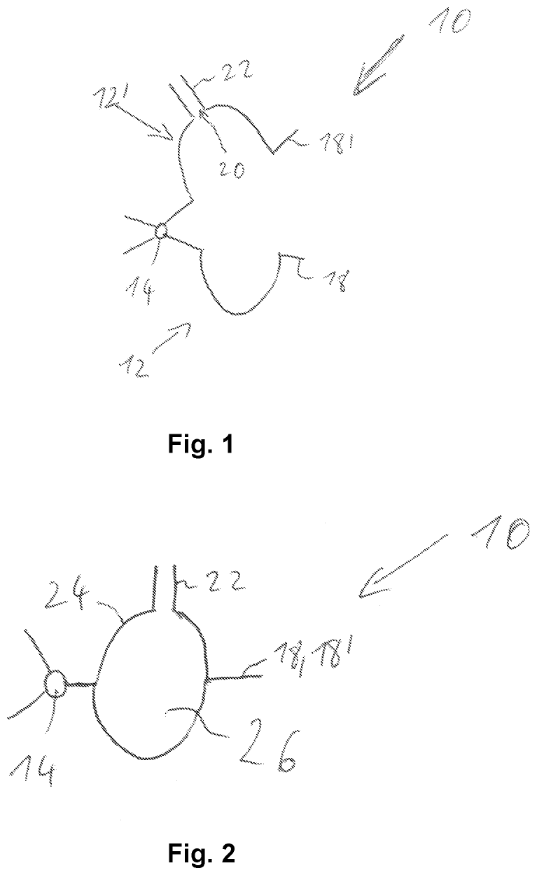

FIG. 1A container suitable for the process according to the invention with a container wall made of a perforated material according to an embodiment of the present invention in the open state.

FIG. 2 the container shown in FIG. 1 in closed state.

The container 10 shown in FIG. 1, suitable for use in the process according to the present invention, comprises two half-calottes 12, 12′ connected to each other by a hinge 14. The two half-calottes 12, 12′ each have the same dimensions and are each formed of the same perforated material, preferably a wire mesh of stainless steel. The equators 16, 16′ of the two half-calottes 12, 12′ each have a radially outwardly projecting collar 18, 18′ of the, which surround the half-calottes 12, 12′ in each case in a circular ring shape. An inlet opening 20 is provided at the pole of the upper half-calotte 12′, above which a tube 22 fixedly connected to the container is arranged. The two half-calottes 12, 12′ form the container wall 24.

In the opened state shown in FIG. 1, a powder compact can be easily introduced into the cavity 26 of the container 10 according to process step iii) and a coated powder compact can be easily removed from the cavity 26 of the container 10 according to process step v). By folding the two half-calottes 12, 12′ together via the hinge 14, the two half-calottes 12, 12′ can be brought together with their equators in a snug fit and closed, as shown in FIG. 2. In this state, the coating liquid can be introduced via the tube 22 and the inlet opening 20 into the cavity 26 of the container according to process step iv) and the container 10 filled with the powder compact and the coating material can be immersed in the hardener liquid container according to process step v).

1. A method for coating a powder compact, in particular for producing a capsule containing beverage powder, comprising the following steps:
i) providing a powder compact of a powder containing at least one polysaccharide,
ii) providing a container having a container wall of a perforated material enclosing a cavity, the container having an inlet opening for introducing coating liquid into the cavity,
iii) placing the powder compact into the cavity of the container, wherein the powder compact is smaller than the volume of the cavity,
iv) introducing a coating liquid containing a coating material into the cavity via the inlet port,
v) immersing the container filled with the powder compact and the coating material in a hardener liquid containing a hardener compound, the viscosity of the hardener liquid being lower than the viscosity of the coating liquid, and
vi) removing the container from the hardener liquid and removing the coated powder compact from the container.

2. The method according to claim 1, wherein the powder compact is spherical and made of a powder of a substance selected from the group consisting of coffee, tea, drinking chocolate, cocoa and milk powder by pressing the powder with a pressure of 0.01 to 1.000 MPa.

3. The method according to claim 1, wherein the container has a spherical cavity.

4. The A method according to claim 1, wherein the perforated material of the container wall is a wire mesh having a mesh size of from 0.01 to 0.30 mm.

5. The method according to claim 4, wherein the wire mesh is made of stainless steel and has a wire thickness of 0.01 to 0.30 mm.

6. The method according to claim 1, wherein a tube firmly connected to the container is arranged above the inlet opening of the container.

7. The method according to claim 6, wherein the tube is a rectangular tube or a round tube having a length of from 1.0 to 5.0 cm.

8. The method according to claim 6, wherein the tube is a round tube having an inner diameter of 0.1 to 5.0 mm.

9. The method according to claim 1, wherein the container comprises two half-calottes, each of the same dimensions and each formed from the perforated material, which are connected via a hinge, the half-calottes enclosing a spherical cavity when the two half-calottes are each placed on top of one another with their equator in a snug fit, one of the half-calottes having the inlet opening at its pole.

10. The method according to claim 1, wherein the inlet opening has a circular cross-section with a diameter of from 0.1 to 5.0 mm.

11. The method according to claim 1, wherein the container is connected in a rack with one or more other containers of the same dimensions, so that several powder compacts can be coated simultaneously.

12. The method according to claim 1, wherein a coating liquid is used which contains a coating material selected from the group consisting of starch, cellulose, chitin, carrageenan, agar and alginates.

13. The method according to claim 1, wherein a hardener liquid is used which contains a hardener compound which crosslinks the coating material via i) covalent bonds or ii) via ionic and/or coordinative bonds.

14. The method according to claim 1, wherein a coating liquid is used which contains an alkali metal alginate as coating material, and a hardener liquid is used which contains an alkaline earth metal salt as hardener compound.

15. The method according to claim 14, wherein an alkali metal alginate solution is used as the coating liquid, and an alkaline earth metal salt solution is used as hardener liquid.

16. The method according to claim 15, wherein the alkali metal alginate solution is an aqueous solution comprising 0.5 to 5% by weight alkali metal alginate.

17. The method according to claim 15, wherein the alkali metal alginate solution is an aqueous solution comprising 0.5 to 5% by weight sodium alginate.

18. The method according to claim 15, wherein the alkaline earth metal salt solution is an aqueous solution comprising 1 to 7% by weight of an alkaline earth metal salt.

19. The method according to claim 15, wherein the alkaline earth metal salt solution is an aqueous solution comprising 1 to 7% by weight calcium chloride.
